(19) United States
(12) Patent Application Publication
(10) Pub. No.: US 2026/0362411 A1
(43) Pub. Date: Nov. 12, 2026

(54) DYNAMIC SUBBAND OPERATION (DSO) SUBBAND NEGOTIATION AND RECONFIGURATION

(71) Applicant: Cisco Technology, Inc., San Jose, CA (US)

(72) Inventors: Binita Gupta, San Diego, CA (US); Brian D. Hart, Sunnyvale, CA (US)

(21) Appl. No.: 19/669,402

(22) Filed: May 6, 2026

Related U.S. Application Data
(60) Provisional application No. 63/800,955, filed on May 6, 2025.
(60) Provisional application No. 63/980,593, filed on Feb. 11, 2026.
(60) Provisional application No. 63/999,173, filed on Mar. 7, 2026.

(51) Int. Cl. H04W 72/0457

(52) U.S. Cl. CPC H04W 72/0457

(57) ABSTRACT

may be provided. An Access Point (AP) may manage access to a wireless communications medium of a wireless network for one or more wireless stations. The AP may operate at a channel bandwidth of 320 MHz spanning a primary channel and a plurality of 80 MHz DSO subbands. The AP may receive a request corresponding to a first wireless station of the one or more wireless stations, the request including information indicating a request to access a DSO mode of the access point and one or more 80 MHz DSO subbands. In response to the request, the AP may select an 80 MHz DSO subband of the plurality of 80 MHz DSO subbands for the first wireless station for the DSO mode. The AP may implement the DSO mode at the access point with the selected DSO subband allocated to the first wireless station.

### RELATED APPLICATION

This application claims the benefit of U.S. Provisional Application No. 63/800,955, filed May 6, 2025, U.S. Provisional Application No. 63/980,593, filed Feb. 11, 2026, and U.S. Provisional Application No. 63/999,173, filed Mar. 7, 2026, which are incorporated herein by reference.

### TECHNICAL FIELD

The present disclosure relates generally to Dynamic Subband Operation (DSO) subband negotiation and reconfiguration.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for Dynamic Subband Operation (DSO) subband negotiation and reconfiguration;

FIG. 2 is a flow chart of a method for DSO subband negotiation and reconfiguration; and

FIG. 3 is a block diagram of a computing device.

### DETAILED DESCRIPTION

### Overview

Dynamic Subband Operation (DSO) subband negotiation and reconfiguration may be provided. An Access Point (AP) may manage access to a wireless communications medium of a wireless network for one or more wireless stations. The AP may operate at a channel bandwidth of 320 MHz spanning a primary channel and a plurality of 80 MHz DSO subbands. The AP may receive a request corresponding to the first wireless station of the one or more wireless stations, the request including information indicating a request to access a DSO mode of the access point and one or more 80 MHz DSO subbands. In response to the request, the AP may select an 80 MHz DSO subband of the plurality of 80 MHz DSO subbands for the first wireless station for the DSO mode. The AP may implement the DSO mode at the access point with the selected DSO subband allocated to the first wireless station.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Dynamic subband operation (DSO) may have been introduced to address a bottleneck that may form in a primary subband of a Basic Service Set (BSS) bandwidth (that may contain a primary 20 MHz channel) with a high volume of traffic. DSO, in one example, may enable an affiliated Access Point (AP) of an AP Multi-Link Device (AP MLD) to make better use of its wider Band Width (BW) (also known as channel width) when its associated Stations (STAs) support narrower BW. An affiliated AP of an AP MLD may move narrow BW STAs to operate on other subbands of its wider operating BW, so the affiliated AP may make use of its entire channel width. For example, an affiliated AP of an AP MLD may be operating at 320 MHz BW and may have associated STAs that may be operating in 20 MHz and 80 MHz BW. In this scenario, the affiliated AP may move some STAs around to a secondary 80 MHz (S80) and secondary 160 MHz (S 160) BW to make use of its wider BW. There may be many subband choices for the affiliated AP to move a STA. In addition, due to hardware constraint, a STA and an affiliated AP may not support all possible subband choices for the DSO. Hence, there may be a need for a STA and an affiliated AP to share their subband capability and negotiate set of one or more subbands where the STA and the affiliated AP may operate in the DSO. Later, as STAs leave a BSS, the affiliated AP may need to perform a subband reconfiguration for remaining associated STAs to evenly distribute subbands across STAs, such that the affiliated AP may again make best use or its entire BW. Embodiments of the disclosure may define a process for subbands negotiation and reconfiguration between STAs and affiliated APs of an AP MLD. The DSO mode of operation may be performed for per link or per affiliated AP of an AP MLD. Each affiliated AP of an AP MLD may have different operating BW and may have separate DSO subband negotiations for associated STAs on that link. A non-AP MLD and an AP MLD may negotiate DSO subbands for one or more links which are setup between the two peer MLDs.

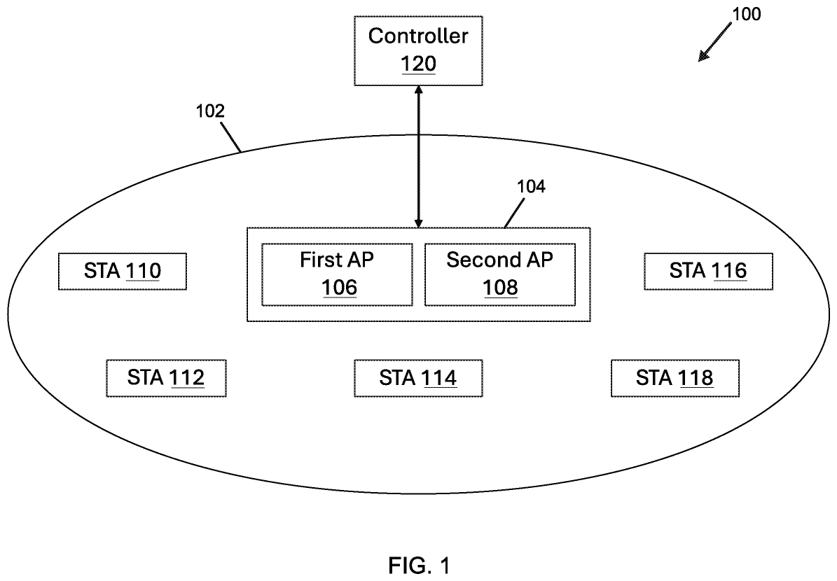

FIG. 1 is a block diagram of an operating environment 100 for DSO subband negotiation and reconfiguration. Operating environment 100 may include a BSS 102 with an AP MLD 104. AP MLD 104 may include a first AP 106 and a second AP 108 as affiliated APs of AP MLD 104. BSS 102 may further include a plurality of STAs, for example, a first STA 110, a second STA 112, a third STA 114, a fourth STA 116, and a fifth STA 118. In some examples, operating environment 100 may include another BSS that may be within range of BSS 102 and be operating on the same channel (e.g., first AP 106 or second AP 108 may have the same primary channel or overlapping channel with different primary channels with another AP of the another BSS). Operating environment 100 may further include a controller 120.

AP MLD 104 (including first AP 106 and second AP 108) may enable a plurality of STAs to connect to a network for example, but is not limited to, a Wireless Local Area Network (WLAN) that may provide wireless network access (e.g., access to the WLAN for the plurality of STAs as they move within the network). Each of first STA 110, second STA 112, third STA 114, fourth STA 116, and fifth STA 118 may be any client device that connects to the network to communicate with other devices on the network and also be referred to as a non-AP MLD. In some examples, first STA 110, second STA 112, third STA 114, fourth STA 116, and fifth STA 118 may be but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Controller 120 may be any network controller (e.g., a WLAN controller) and may manage first AP 106, second AP 108, and/or other network devices to allow wireless devices such as first STA 110, second STA 112, third STA 114, fourth STA 116, and fifth STA 118 to connect to the network. Controller 120 may comprise a Wireless Local Area Network (LAN) Controller (WLC) and may provision and control the coverage environment (for example, a WLAN). In some implementations of the disclosure, controller 120 may be implemented by a Digital Network Architecture Center (DNAC) controller (i.e., a Software-Defined Network (SDN) controller.

Each of the plurality of APs and the plurality of STAs may be compatible with specification standards such as, but not limited to, the Institute of Electrical and Electronics Engineer (IEEE) 802.11 specification standard for example. The plurality of APs and the plurality of STAs of operating environment 100 may use Multi-Link Operation (MLO) where they simultaneously transmit and receive across different bands and channels by establishing two or more links to two or more AP radios. These bands may comprise, but are not limited to the 2.4 GHz band, the 5 GHz band, the 6 GHz band, and the 60 GHz band. Operating environment 100 is an example configuration and there may be a different number of BSSs, STAs, APs, controllers, and/or other devices in further examples.

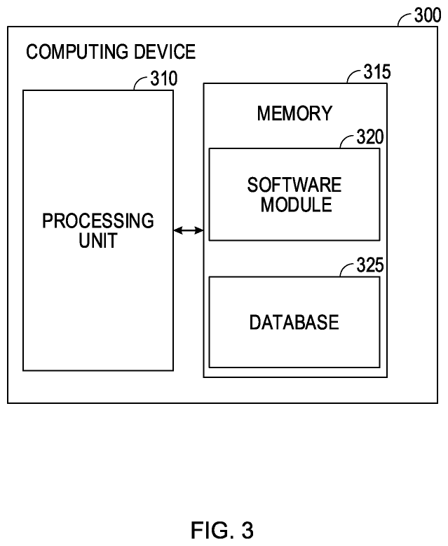

The elements described above of operating environment 100 (e.g., first AP 106, second AP 108, first STA 110, second STA 112, third STA 114, fourth STA 116, fifth STA 118, and controller 120) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

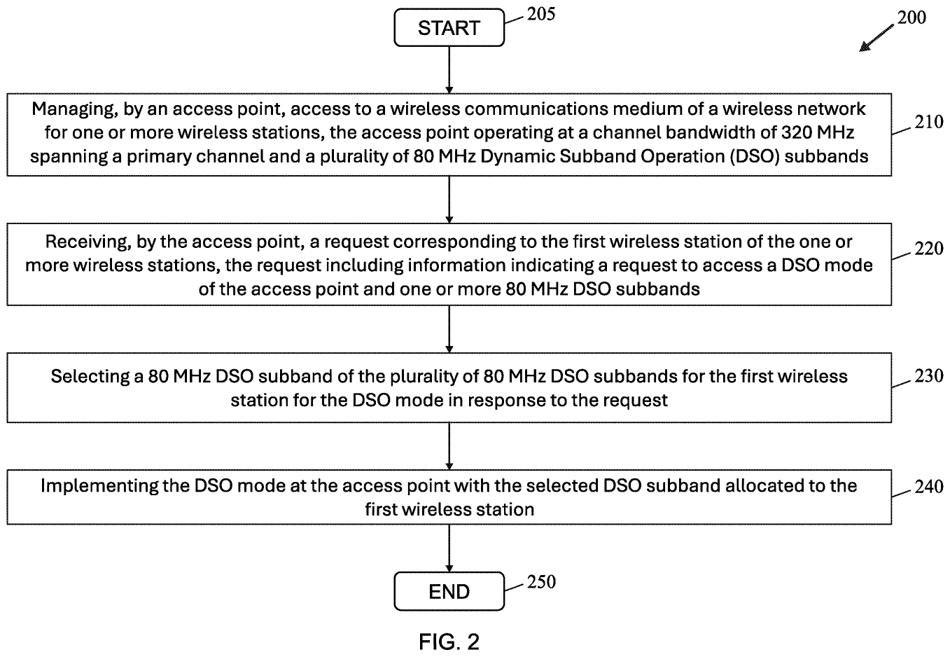

FIG. 2 is a flow chart setting forth the general stages involved in a method 200 consistent with implementations of the disclosure for DSO subband negotiation and reconfiguration. Method 200 may be implemented using any of the affiliated APs of AP MLD 104 (that is, first AP 106 and/or second AP 108), and controller 120 as described in more detail above with respect to FIG. 1. Ways to implement the stages of method 200 will be described in greater detail below. Method 200 is being described with respect to first AP 106 of AP MLD 104, however it may be performed second AP 108 of AP MLD 104.

Method 200 may begin at starting block 205 and proceed to stage 210 where AP MLD 104 may manage access to a wireless communications medium of a wireless network for one or more wireless STAs. First AP 106 of the AP MLD 104 may operate at a channel bandwidth of 320 MHz spanning a primary subband (that includes the primary channel of the first AP 106) and a plurality of 80 MHz DSO subbands.

First AP 106 may signal that it may be capable of DSO. In some examples, first AP 106 may signal DSO support in an Ultra High Reliability (UHR) Medium Access Control (MAC) capabilities signal. In addition, in one implementation, first AP 106 may signal that DSO mode is enabled at first AP 106 in a UHR operation element. Moreover, in some implementations, first AP 106 may explicitly signal whether it supports DSO for 20 MHz STAs, 80 MHz STAs, and/or 160 MHz STAs. Support for DSO BWs may be signaled as part of first AP 106 DSO parameters in a beacon, a probe response, (re)association response, etc. In one example, for DSO support for 20 MHz STAs, when operating with 40 or 80 MHz BSS BW, first AP 106 may signal that it may support DSO for 20 MHz STAs. In addition, when first AP 106 is operating with 40 MHz BSS BW, a secondary 20 or S20 subband may be the only possible DSO subband. Moreover, when first AP 106 is operating with 80 MHz BSS BW, the S20 subband and two 20 MHz subbands in a S40 subband may be possible DSO subbands. Furthermore, when first AP 106 of is operating with 160 or 320 MHz BSS BWs, there may be a lot more 20 MHz possible DSO subbands. For example, for 160 MHz BW, there may be seven possible 20 MHz DSO subbands and for 320 MHz BW there may be fifteen possible 20 MHz DSO subbands.

As discussed above, first AP 106 may explicitly signal whether it supports DSO for 20 MHz-only STAs, 80 MHz STAs, and/or 160 MHz STAs. This may be signaled as part of first AP 106 DSO parameters in one or more of a beacon, a probe response, a (re)association response, etc. First AP 106 may support all or a subset of possible 20 MHz DSO subbands in its BSS operating BW for 20 MHz STAs. AP MLD 104 may indicate the set of 20 MHz DSO subbands that it may support as part of first AP 106 DSO parameters. In one example, first AP 106 may support all possible 20 MHz DSO subbands and may single this using a single bit (indicating all 20 MHz DSO subbands supported). When first AP 106 is operating in 160 MHz BW, it may only have one 80 MHz DSO subband. If first AP 106 indicates DSO support for 80 MHz STAs, then it may not need to explicitly list support for 80 MHz DSO subband, since only one 80 MHz DSO subband is possible. In addition, first AP 106 may indicate its support for the only DSO 80 MHz subband.

When first AP 106 of is operating in 320 MHz BW, then first AP 106 may have three possible 80 MHz DSO subbands. First AP 106 of, however, may not support all three of these 80 MHz DSO subbands. Therefore, first AP 106 of may indicate a set of 80 MHz DSO subbands that it supports as part of first AP 106 DSO parameters. In one example, first AP 106 of may support all three 80 MHz DSO subbands and then may signal its support for the 80 MHz DSO subbands using a single bit indicating all 80 MHz DSO subbands may be supported.

First AP 106 DSO capabilities and/or parameters (for example, DSO supported for which BWs (20 MHz, 80 MHz, 160 MHz, etc.) and supported set of DSO subbands of 20 MHz and 80 MHz BWs) may be provided in the UHR capabilities element, in the UHR operation element (when included in a probe response, an association response, a reassociation response, etc.), or in another element carrying operating parameters for the UHR operating modes (for example, UHR operation parameters element or another name).

After managing access to the wireless communications medium of the wireless network for the one or more wireless STAs at stage 210, method 200 may proceed to stage 220 where first AP 106 may receive a request corresponding to first STA 110 of the one or more STAs, the request including information indicating a request to access a DSO mode of operation for first AP 106 and one or more 80 MHz DSO subbands that first STA 110 may support.

First STA 110 that operates with 80 MHz BW may support one, two, or three DSO subbands of 80 MHz. If first AP 106 is operating with 160 MHz BW, the secondary 80 or S80 subband may be the only DSO subband and no negotiation may be needed between AP MLD 104 and first STA 110 (that is, 80 MHz STA) for the DSO subband operation for first AP 106. When first AP 106 is operating with 320 MHz BW, there may be three possible 80 MHz DSO subbands. First AP 106 may support all three possible 80 MHz subbands or a smaller number of 80 MHz DSO subbands as described above. For DSO scheduling flexibility, first STA 110 may be needed to support at least two or all three DSO subbands as possible DSO subbands. First STA 110 may indicate its possible DSO subbands supported (for example, one or two or three 80 MHz DSO subbands) and whether it supports maximum of one, two, or three 80 MHz DSO subbands for the DSO mode.

When first AP 106 is operating in 320 MHz BW, there may be a need for a DSO subband negotiation between first STA 110 and first AP 106 for the DSO subbands to use for the DSO mode. First STA 110 may send a DSO request indicating possible 80 MHz DSO subbands (for example, one, two, or three 80 MHz DSO subbands) that first STA 110 may support. First STA 110 may additionally indicate a maximum number of DSO subbands that it may support out of those DSO subbands for the DSO mode. In one example, first STA 110 may support only one or two of those DSO subbands for the DSO mode.

Once having received the request corresponding to first STA 110 of the one or more wireless STAs at stage 220, method 200 may proceed to stage 230 where first AP 106, in response to the request, may select an 80 MHz DSO subband of the plurality of 80 MHz DSO subbands for first STA 110 for the DSO mode in response to the request.

First AP 106 after receiving the DSO request from a STA, may choose set of one or more DSO subbands (based on the STA's maximum limit for DSO subbands for the DSO mode) for that STA and send it to the STA in a DSO response. For example, first AP 106 after receiving the DSO request from first STA 110 may choose 80 MHz DSO subbands (based on first STA's 110 maximum limit indicated for DSO subbands for the DSO mode) for first STA 110. First AP 106 may choose a set of 80 MHz DSO subbands for first STA 110 such that associated STAs may be well distributed across possible 80 MHz DSO subbands supported by first AP 106.

After selecting the 80 MHz DSO subband of the plurality of 80 MHz DSO subbands for first STA 110 for the DSO mode in response to the request at stage 230, method 200 proceed to stage 240 where first AP 106 may implement the DSO mode at first AP 106 with the selected DSO subband allocated to first STA 110. For example, first AP 106 may send the selected DSO subbands to first STA 110 (for 80 MHz subbands) in a DSO response. First STA 110 may accept the response from first AP 106. First AP 106 and first STA 110 may now operate in the DSO mode using the negotiated 80 MHz DSO subbands. Once having implemented the DSO mode with the selected DSO subband with first STA 110 at stage 240, method 200 may terminate at end block 250.

For a STA operating in the 20 MHz BW, as discussed above, given there are many 20 MHz DSO subbands, such STA (for example, second STA 112) may not be able to support all of these DSO subbands (for example, due to hardware constraints). First AP 106 may also support only a subset of 20 MHz DSO subbands. Hence, there may need to be a negotiation between first AP 106 and second STA 112 about which 20 MHz DSO subbands may be used.

Second STA 112 may send a DSO request indicating one or more possible 20 MHz DSO subbands that second STA 112 may support. In addition, second STA 112 may indicate a maximum number of DSO subbands that second STA 112 may support out of those DSO subbands for the DSO mode. For example, second STA 112 may indicate that it supports three possible DSO subbands but may only support a maximum of one or two out of those three DSO subbands for the DSO mode.

As discussed above, for scheduling flexibility and efficiency at first AP 106, second STA 112 may be required to support multiple DSO subbands. For example, in 80 MHz BSS operating BW, second STA 112 may be required to support a minimum of two 20 MHz DSO subbands, in 160 MHz, first STA 110 may be required to support four 20 MHz DSO subbands, and in 320 MHz, first STA 110 may be required to support eight 20 MHz DSO subbands. First AP 106 may choose a set of 20 MHz DSO subbands for second STA 112 such that associated STAs may be well distributed across possible 20 MHz DSO subbands supported by AP MLD 104.

When AP MLD 104 performs negotiation of the DSO subbands with associated STAs for the affiliated APs of AP MLD 104 (that is, first AP 106 and second AP 108), and allocates one or more DSO subbands to the associated STAs for those affiliated APs, AP MLD 104 may try to distribute the associated STAs across the available DSO subbands for those affiliated APs as described above. However, given that one or more STAs may disassociate and leave BSS 102, distribution of the remaining associated STAs across the DSO subbands for affiliated APs may not remain uniform over time. Hence, there may be a need for AP MLD 104 to reconfigure (or renegotiate) the DSO subbands for its affiliated APs for one or more remaining associated STAs so that AP MLD 104 may redistribute remaining associated STAs uniformly over its available DSO subbands for affiliated APs for efficient utilization of its BSS wide BW using the DSO.

In example, first AP 106 of the AP MLD 104 may be operating at 320 MHz and may have fifteen associated STAs. First AP 106 may distribute five STAs on each of its three 80 MHz DSO subbands, assuming STAs can support any of those DSO subbands. Over time five STAs connected on a S80 subband may get disassociated from AP MLD 104, and hence first AP 106 may not have any STA to allocate to the S80 DSO subband. Then AP MLD 104 may perform a DSO subband reconfiguration and renegotiation to allocate some STAs to the S80 subband for first AP 106. In such an example, AP MLD 104 may send an unsolicited message (for example, a DSO request, a DSO response, or a DSO parameters update notification) to one or more remaining associated STAs. The unsolicited message may signal updated DSO subband(s) to an associated STA with a status or mode indicating “Accept”, “Dictate”, “Suggest” or “Renegotiate”. In the first two modes, an associated STA may accept the updated DSO subbands. In the “suggest” mode, an associated STA may be requested to negotiate the DSO subbands with AP MLD 104 with a suggested set of DSO subbands. In the “renegotiate” mode, AP MLD 104 may be asking an associated STA to renegotiate the DSO subbands, but may continue to schedule that associated STA on currently negotiated DSO subbands for some time period. The time period may be indicated in the unsolicited message from AP MLD 104.

AP MLD 104 may also signal that the DSO mode agreement is cancelled at first AP 106 for an associated STA and request that associated STA renegotiate the DSO subbands without any suggested DSO subbands. The associated STA, based on unsolicited indication from AP MLD 104, may perform DSO subbands renegotiation with AP MLD 104 using method 200.

As discussed above, after one or more STAs leave BSS 102, the DSO subbands distribution for BSS 102 or AP MLD 104 may not be as desired or ideal. For example, remaining associated STAs may not be uniformly distributed over available DSO subbands leading to suboptimal use of first AP 106 BSS operating BW. Moreover, when first AP 106 expands its BW or changes its BW to a wider BW using baseline Operating Mode Notification (OMN) scheme, then some parts of expanded BW may not be used for the DSO subbands because existing DSO subbands allocations do not cover the expanded BW. In these scenarios, AP MLD 104 may recommend and perform reconfiguration of the DSO subbands with one or more associated STAs on that link to use the expanded BW for DSO.

AP MLD 104 may send an action frame to one or more associated STAs to request renegotiation or reconfiguration of the DSO subbands for one or more links or affiliated APs. AP MLD 104 may also request a STA to perform DSO negotiation for some links or affiliated APs for which no DSO subband is negotiated (that is, request a STA to perform the DSO negotiation). In one example, the action frame may indicate whether the request for the DSO subband (re)negotiation is optional, mandatory, strongly desired, etc.

The action frame may be a UHR link reconfiguration notify frame with a new type value (for example, type 5, or another reserved type value) defined to indicate that the action frame is for the DSO subband renegotiation. That is, Type <x> may be defined as a notification from the DSO AP to request or recommend that a STA initiates a DSO subband renegotiation. In one example, an existing type defined for the DSO may be used in the action frame. In another example, the action frame may indicate whether the current DSO subband that is already negotiated is cancelled or still valid for a given link. A reconfiguration multi-link element may be included in the action frame to indicate links or affiliated APs for which the DSO subband (re)negotiation is requested for. For each link for which the DSO subband (re)negotiation is requested may be indicated by including a per-STA profile for that link and indicating in a STA control or a STA information that the DSO subband negotiation is requested (for example, using reserved bits in the existing DSO fields defined or using new fields). The STA information or STA control field may also indicate whether the currently negotiated DSO subband is cancelled or still valid for the link and/or indicate AP MLD's 104 preference level for the DSO subband (re)negotiation request (for example, optional, mandatory, strongly desired, etc.). In one example, the reconfiguration multi-link element may indicate that the currently negotiated DSO subband is being cancelled for one or more links, without explicitly requesting for the DSO subband renegotiation. Then it may be up to a receiving STA to perform the DSO subband negotiation. In another example, a new reconfiguration operation type value(s) may be defined for this purpose, such as: ‘DSO Subband (re)negotiation requested’ and ‘DSO Subband cancelled’.

After receiving such action frame, an STA may take appropriate steps to perform the DSO subband (re)negotiation with AP MLD 104 for the requested links in the action frame using an Operation Management Procedure (OMP) request, response, and confirm procedure as defined for the DSO. If the current DSO subband is cancelled for one or more links by AP MLD 104, then the STA (and AP MLD 104) may stop using those DSO subbands.

In examples, if the STA may not perform the DSO subband (re)negotiation for one or more of the requested links by AP MLD 104, then the STA may send a follow-up action frame. For example, the STA may send another UHR link reconfiguration notify frame with the same type value as used in the UHR link reconfiguration notify frame from AP MLD 104 (and with a same dialog token), to indicate to AP MLD 104 that STA may not accept the DSO (re)negotiation for one or more links and may prefer to continue to operate with the currently negotiated DSO subband.

In some examples, to renegotiate the DSO subbands, AP MLD 104 may send a UHR link reconfiguration notify frame or an unsolicited OMP response frame to an associated STA. The UHR link reconfiguration notify frame may query or nudge the associated STA to renegotiate a new DSO subband as described above, and then STA may initiate a DSO subband negotiation based on the received UHR link reconfiguration notify frame.

In one example implementation, the UHR link reconfiguration notify frame sent by AP MLD 104 may also include a recommended DSO subband or a list of recommended DSO subbands. Then the associated STA may choose one of those DSO subbands and may indicate the selected DSO subband in another UHR link reconfiguration notify frame sent to AP MLD 104 (for example, an OMP confirm frame). The UHR link reconfiguration notify frame may accept the DSO subband or one of the DSO subbands, or may reject the DSO subband recommended by AP MLD 104.

If the unsolicited OMP response from AP MLD included only one recommended DSO subband, then the OMP confirm frame from the STA may indicate either accept or reject for that recommended DSO subband. In this scenario, the OMP confirm frame may not carry any DSO subband.

The UHR link reconfiguration notify frame may indicate whether the currently negotiated DSO subband is kept when STA rejects the recommended DSO subband. In one example, an amendment may define one or more rules that the current DSO subband may be kept if the STA rejects the recommended DSO subband. In another example, the DSO subband may be cancelled when the recommendation is provided. If the STA rejects the recommendation, then the STA may have to renegotiate another DSO subband.

In one example implementation, AP MLD 104 may send a UHR link reconfiguration request frame (instead of a UHR link reconfiguration notify frame) to recommend a new DSO subband.

In another example implementation, after the first affiliated AP 106 of the AP MLD 104 expands BW due to Dynamic Bandwidth Expansion (DBE) or using OMN mechanism, STAs may try to not renegotiate the DSO subband with AP MLD 104 over the expanded BW, and may wait for AP MLD 104 to send a recommendation for a different DSO subband for first AP 106 over the expanded BW. This waiting may avoid a storm of STAs trying to renegotiate the DSO subband over the expanded BW.

In yet another example implementation, AP MLD 104 may recommend a DSO subband for first AP 106 to an STA by sending an unsolicited OMP response even when DBE BW is not expanded. In such example implementation, AP MLD 104 may suggest a DSO subband for first AP 106 to the STA that has not negotiated a DSO subband or may recommend an updated DSO subband to another STA that has already negotiated a DSO subband. The STA may accept or reject the recommended DSO subband by sending an OMP confirm with an appropriate status code.

In yet another example implementation, for first AP 106 of the AP MLD 104 and a STA may pre-negotiate a DSO subband to be used for 320 MHz DBE bandwidth. So, if first AP 106 is a DBE supporting AP and also supports DSO, an 80 MHz STA that supports both DBE and DSO may use an OMP request to pre-negotiate a DSO subband over 320 MHz. The OMP request may indicate a field signaling DSO pre-negotiation for 320 MHz. This negotiation may follow the OMP request, response, confirm signaling as defined for the DSO, except that the negotiated DSO subband may be for a future use when AP MLD 104 expands the BW to 320 MHz. The STA may have another DSO subband negotiated currently. For example, if BSS BW of for first AP 106 is 160 MHz, the STA may have negotiated the S80 subband as the current DSO subband, and may have a different DSO subband negotiated for 320 MHz subband. Later when first AP 106 expands the BW to 320 MHz, the STA may know its negotiated DSO subband and may operate over that DSO subband.

In an Adaptive Operating Mode (AOM) feature, a STA may provide a Disabled Subchannel Bitmap (DSB) indicating a set of punctured 20 MHz subchannels. In one example, the STA may indicate a set of AOM DSBs to AP MLD 104 for each affiliated APs, one for each of operating BWs that the affiliated AP of AP MLD 104 may support for DBE (for example, 80 MHz, 160 MHz, 320 MHz, or 640 MHz in future) based on a maximum DBE bandwidth supported, as part of enabling AOM mode. AP MLD 104 and the STA may maintain multiple sets of AOM DSB per BW for each affiliated AP. Then, later when the DBE BW is expanded, AP MLD 104 and the STA both may use the AOM DSB pre-negotiated for that DBE BW. This may avoid renegotiating a new AOM DSB every time DBE BW changes.

A STA may change its negotiation for the AOM DSB for multiple BWs using an OMP request/response exchange. A mode specific parameter in the UHR mode change element for an AOM mode may be enhanced to support the AOM DSB for multiple BWs. In another example, every time DBE BW changes, a STA may end up renegotiating AOM DSB (using an OMP request/response exchange) if the STA has additional 20 MHz punctured subchannels in the expanded part of the DBE BW. If the STA does not have any additional 20 MHz punctured subchannels in the expanded part of the DBE BW, then the STA may not need to update its AOM DSB. Then still the old AOM DSB may be used with no 20 MHz subchannels punctured in the expanded part of the DBE BW.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for DSO subband negotiation and reconfiguration as described above with respect to FIG. 2. Computing device 300, for example, may provide an operating environment for first AP 106, second AP 108, first STA 110, second STA 112, third STA 114, fourth STA 116, fifth STA 118, and controller 120. First AP 106, second AP 108, first STA 110, second STA 112, third STA 114, fourth STA 116, fifth STA 118, and controller 120 may operate in other environments and are not limited to computing device 300.

Computing device 300 may be implemented using a Wi-Fi AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
managing, by an access point, access to a wireless communications medium of a wireless network for one or more wireless stations, the access point operating at a channel bandwidth of 320 MHz spanning a primary channel and a plurality of 80 MHz Dynamic Subband Operation (DSO) subbands;
receiving, by the access point, a request corresponding to a first wireless station of the one or more wireless stations, the request comprising information indicating a request to access a DSO mode of the access point and one or more 80 MHz DSO subbands;
selecting an 80 MHz DSO subband of the plurality of 80 MHz DSO subbands for the first wireless station for the DSO mode in response to the request; and
implementing the DSO mode at the access point with the selected DSO subband allocated to the first wireless station.

2. The method of claim 1, further comprising:
transmitting, by the access point, a response to the request, wherein the response includes information that indicates the selected 80 MHz DSO subband.

3. The method of claim 2, further comprising:
receiving an acceptance of the selected DSO subband from the first wireless station, wherein the implementing the DSO mode of operation occurs after the acceptance.

4. The method of claim 3, wherein the selected DSO subband is different from the DSO subband indicated in the request.

5. The method of claim 1, further comprising:
advertising, by the access point, support for the DSO mode of operation.

6. The method of claim 3, further comprising:
transmitting, by the access point, one or more unsolicited messages including information indicating:
a request to renegotiate the DSO subband for the first wireless station; and
an updated DSO subband for the first wireless station.

7. The method of claim 6, wherein the request to renegotiate the DSO subband is triggered by a determination to rebalance an allocation of DSO subbands to wireless stations associated with the access point.

8. A wireless access point comprising:
at least one memory element for storing data; and
at least one processor for executing instructions associated with the data, wherein executing the instructions causes the wireless access point to perform operations, comprising:
managing, by the access point, access to a wireless communications medium of a wireless network for one or more wireless stations, the access point operative at a channel bandwidth of 320 MHz spanning a primary channel and a plurality of 80 MHz Dynamic Subband Operation (DSO) subbands;
receiving, by the access point, a request corresponding to a first wireless station of the one or more wireless stations, the request comprising information indicating a request to access a DSO mode of the access point and one or more 80 MHz DSO subbands;
selecting an 80 MHz DSO subband of the plurality of 80 MHz DSO subbands for the first wireless station for the DSO mode in response to the request; and
implementing the DSO mode at the access point with the selected DSO subband allocated to the first wireless station.

9. The access point of claim 8, the operations further comprising:
transmitting, by the access point, a response to the request, wherein the response includes information that indicates the selected 80 MHz DSO subband.

10. The access point of claim 9, the operations further comprising:
receiving an acceptance of the selected DSO subband from the first wireless station, wherein the implementing the DSO mode of operation occurs after the acceptance.

11. The access point of claim 10, wherein the selected DSO subband is different from the DSO subband indicated in the request.

12. The AP of claim 8, the operations further comprising:
advertising, by the access point, support for the DSO mode of operation.

13. The system of claim 8, the operations further comprising
transmitting, by the access point, one or more messages including information indicating a request to renegotiate the DSO subband for the first wireless station.

14. The system of claim 13, wherein the request to renegotiate the DSO subband is triggered by a determination to rebalance an allocation of DSO subbands to wireless stations associated with the BSS.

15. A non-transitory computer-readable medium that stores a set of instructions which when executed perform a method executed configure one or more processors of a wireless access point (AP) to perform operations comprising:
managing, by the access point, access to a wireless communications medium of a wireless network for one or more wireless stations, the access point operative at a channel bandwidth of 320 MHz spanning a primary channel and a plurality of 80 MHz Dynamic Subband Operation (DSO) subbands;
receiving, by the access point, a request corresponding to a first wireless station of the one or more wireless stations, the request including information indicating a request to access a DSO mode of the access point and one or more 80 MHz DSO subbands;
selecting an 80 MHz DSO subband of the plurality of 80 MHz DSO subbands for the first wireless station for the DSO mode in response to the request; and
implementing the DSO mode at the access point with the selected DSO subband allocated to the first wireless station.

16. The non-transitory computer readable storage medium of claim 15, the operations further comprising:
transmitting, by the access point, a response to the request, wherein the response includes information that indicates the selected 80 MHz DSO subband.

17. The non-transitory computer readable storage medium of claim 16, the operations further comprising:
receiving an acceptance of the selected DSO subband from the first wireless station, wherein the implementing the DSO mode of operation occurs after the acceptance.

18. The non-transitory computer readable storage medium of claim 17, wherein the selected DSO subband is different from the DSO subband indicated in the request.

19. The non-transitory computer readable storage medium of claim 15, the operations further comprising:
advertising, by the access point, support for the DSO mode of operation.

20. The non-transitory computer readable storage medium of claim 15, the operations further comprising:
transmitting, by the access point, one or more messages including information indicating a request to renegotiate the DSO subband for the first wireless station.

21. The non-transitory computer readable storage medium of claim 20, wherein the request to renegotiate the DSO subband is triggered by a determination to rebalance an allocation of DSO subbands to wireless stations associated with the BSS.
